(19) United States
(12) Patent Application Publication
(10) Pub. No.: US 2012/0191831 A1
(43) Pub. Date: Jul. 26, 2012

(54) SYSTEM AND METHOD FOR CATALOGING ASSETS IN A NETWORK

(76) Inventors: Carl Kanzabedian, Houston, TX (US); Chandra H. Kamalakantha, Plano, TX (US)

(21) Appl. No.: 13/013,974

(22) Filed: Jan. 26, 2011

(51) Int. Cl. G06F 15/173

(52) U.S. Cl. 709/223

(57) ABSTRACT

According to one example of the present invention, there is provided a system for cataloging assets in a network. The network comprises a plurality of computing devices and at least some of the computing devices include asset description data. The system comprises a network explorer to send a request on a network address of the network to obtain asset description data, to receive asset description data from a computing device connected to the network address, and to store the retrieved asset description data in a data store. The system further comprises an asset description data processor to process the data in the data store to identify known relationships between assets in the network, to infer relationships between assets in the network, and to update stored asset description data in the data store with relationship data describing any determined or inferred relationships with other assets.

### BACKGROUND

To effectively manage an information technology (IT) system or infrastructure it is important for IT system managers to have an accurate representation of the composition and structure of the infrastructure. Typically an IT infrastructure comprises a multitude of hardware and software IT assets. Hardware assets may include, for example, computing devices, network devices, and storage devices, and software assets may include operating systems and software components, and software applications.

For small businesses or organizations with a small IT infrastructure it is generally relatively easy for an IT system manager to determine the hardware and software assets of the IT infrastructure. For example, for a small business having a single geographical site it may be as easy as the administrator performing a visual audit of the different IT equipment on the site, or consulting a locally held list of assets.

However, for larger businesses or organizations having a more dynamic IT infrastructure, the task is considerably more complex. For example, in an organization spanning multiple offices in multiple geographic locations there may be many different people who have responsibilities for different parts of the organization's IT infrastructure, making it difficult to accurately determine the composition and structure thereof. Furthermore, in many instances IT assets may be regularly added, removed, upgraded, etc., and relationships between different IT assets may be regularly modified, further complicating the task of understanding the composition and structure of the IT infrastructure.

### BRIEF DESCRIPTION

Examples and embodiments of the invention will now be described, by way of non-limiting example only, with reference to the accompanying drawings, in which:

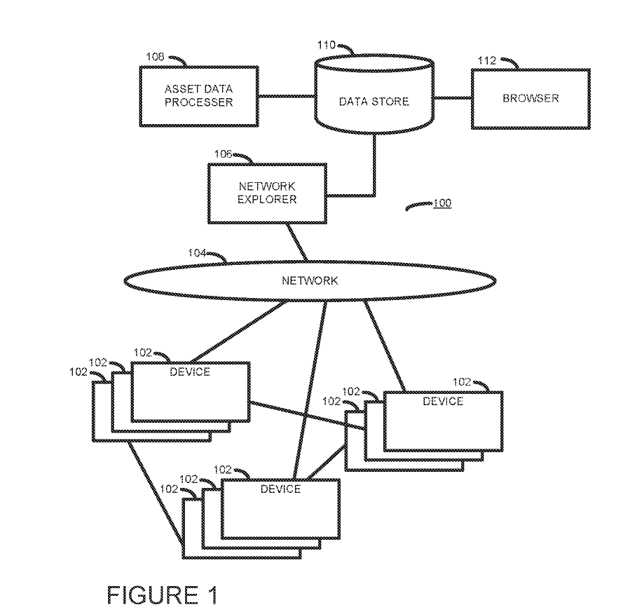

FIG. 1 is a simplified block diagram showing an overview of a system according to one example of the present invention;

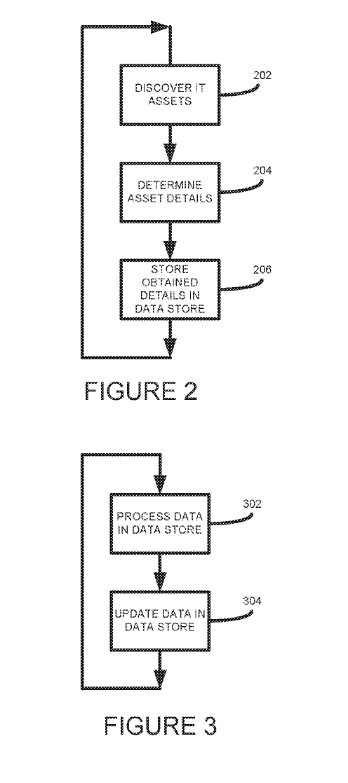

FIG. 2 is a simplified flow diagram outlining an example method of operating an element of the system according to an example of the present invention;

FIG. 3 is a simplified flow diagram outlining an example method of operating an element of the system according to an example of the present invention;

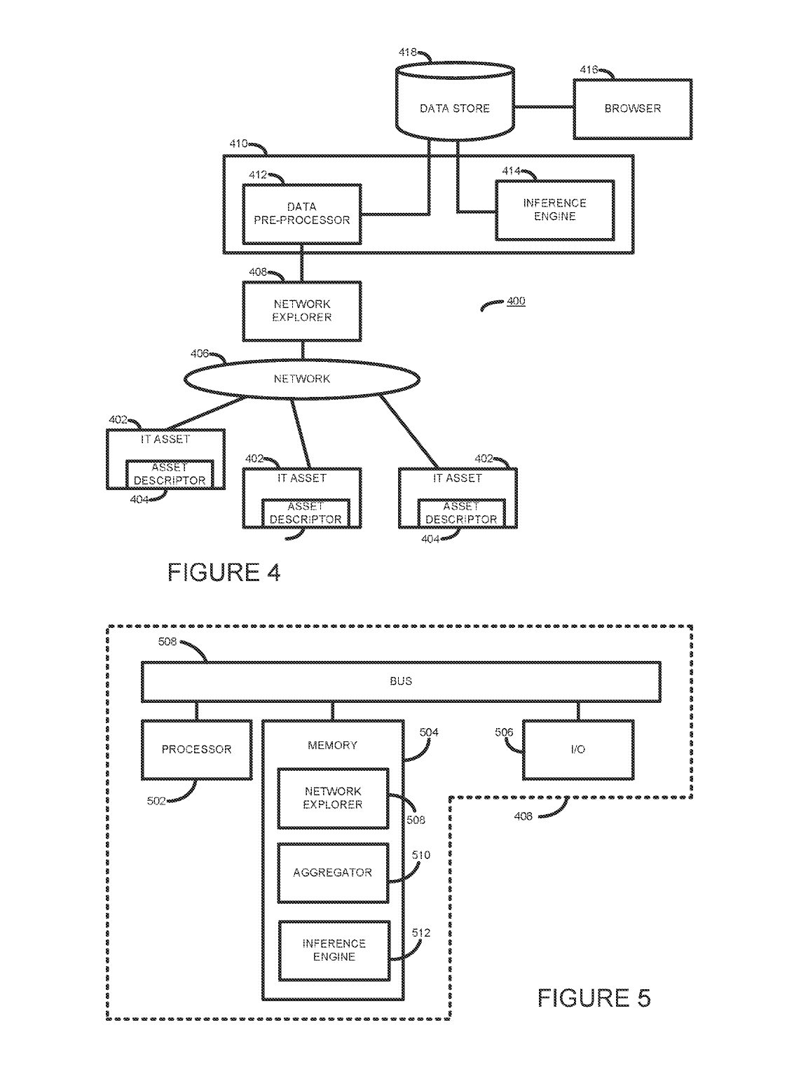

FIG. 4 is a simplified block diagram showing an overview of a system according to one example of the present invention;

FIG. 5 is a simplified block diagram showing an overview of a system according to one example of the present invention;

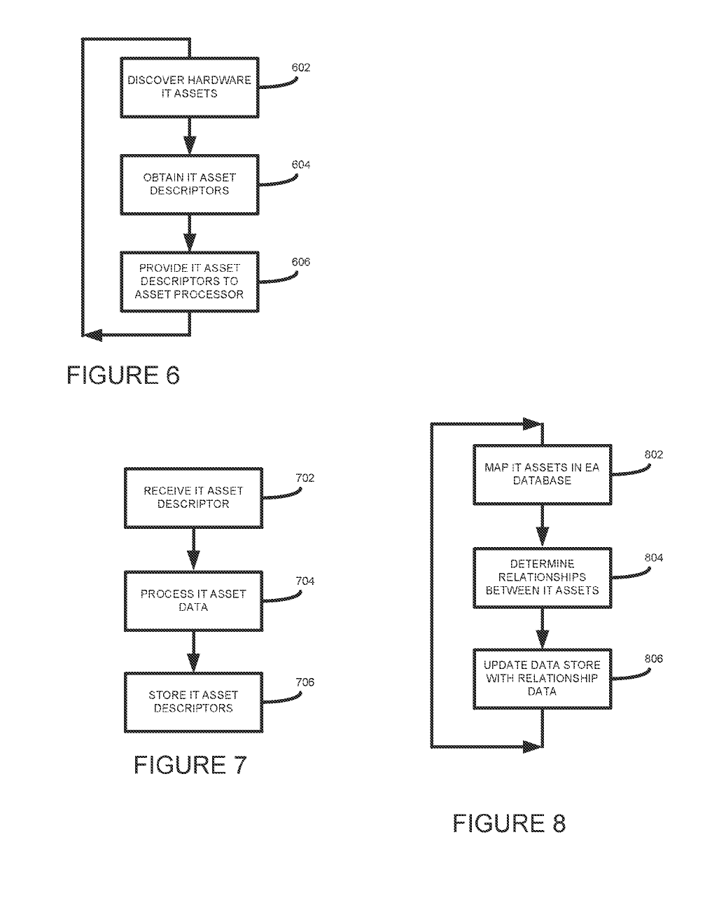

FIG. 6 is a simplified flow diagram outlining an example method of operating an element of the system according to an example of the present invention;

FIG. 7 is a simplified flow diagram outlining an example method of operating an element of the system according to an example of the present invention; and

FIG. 8 is a simplified flow diagram outlining an example method of operating an element of the system according to an example of the present invention.

### DETAILED DESCRIPTION

As previously described, in many large organizations it is difficult to accurately determine the composition of an IT system or infrastructure. Examples and embodiments of the present invention, as described below, however, provide systems and methods that enable the composition and structure of an IT system or infrastructure to be catalogued or determined to a good degree of accuracy. Furthermore, the details of the composition and structure of the IT system are stored in a data store, such as an enterprise architecture data store, in a manner which enables an IT system manager to easily and clearly visualize the composition and structure of the IT system. Advantageously, in one example the IT system may be repeatedly analyzed and the data store repeatedly updated, to ensure that any changes in the composition or structure of the IT system are accurately reflected or catalogued in the data store. In this way, the enterprise architecture may be kept substantially up-to-date, thereby enabling the IT system to be managed using accurate and up-to-date data of any hardware and software assets in the IT system.

Referring now to FIG. 1 there is shown a block diagram illustrating an overview of an IT system 100 according to an example of the present invention. The operation of elements of the system 100 is further described with additional reference to the flow diagram of FIG. 2.

The IT system 100 includes a number of hardware IT assets 102 connected to a computer network 104. The hardware IT assets 102 may include, for example, any suitable network connected or network connectable devices, such as computer servers, desktop computers, portable computers, mobile computing devices, smart-phones, networking devices, communication devices, storage devices, and the like. The IT system 100 additionally includes a network explorer 106, an asset data processor 108, a data store 110, and a browser 112. The hardware IT assets 102 may, depending on particular configurations, also be connected to other hardware IT assets 102.

Some of the hardware IT asset may also comprise one or more software IT assets, such as an operating system, a software component, a software application, and the like.

The network explorer 106 operates to analyze or explore (202) the network 104 to discover (202) hardware IT assets connected thereto. In one example the network explorer 106 operates like a web crawler, web spider, web robot, or the like, using a systematic or methodical approach to exploring network addresses within the network address space of the IT system 100. In another example, the network explorer 106 may be supplied with a list of known network addresses allocated to hardware IT assets, and may explore the known network addresses. The known network addresses may, in one example, be provided by a network element such as dynamic host configuration protocol (DHCP) router or server.

When a hardware IT asset is discovered at a network address the network explorer 106 attempts to determine (204) details of the hardware IT asset. In one example, the network explorer 106 may request that the hardware IT asset provides asset description data stored therein.

The obtained asset description data may include, for example, data relating to hardware characteristics of the hardware IT asset, such as the general functionality of the asset (such as, general purpose computer, computer service, network router, storage device, etc.), the manufacturer of the asset, the age of the asset, technical characteristics of the asset (such as, processor type, memory size, storage capacity, firmware version, etc.), other assets to which the asset is connected or is related, or any other data related to the asset.

In one example the obtained IT asset description data may additionally include software IT asset description data relating to characteristics of software components of the hardware IT asset. For example, the software asset description data may include data describing the name and version number of operating systems, software applications, programs, drivers, and other components, present on the hardware IT asset. In one example the software asset description data includes characteristics of software currently running on the device. In a further example, the software asset description data includes characteristics of software currently installed on the device.

In a further example, if the network explorer 106 determines that a computing device does not include asset description data it may attempt to determine data about the device in other ways. For example, the network explorer 106 may be able to determine IT asset description data, for example describing the, or at least part of the, functionality of the IT asset through use of probing or inspection techniques. Probing may include, for example, sending messages or control signals to the IT asset on one or more ports thereof, and analyzing the response thereto. For example, the messages or control signals may be sent using a variety of different known protocols, and the network explorer 106 may match the response to the sent messages to known or expected responses to deduce or imply certain IT asset description data.

The network explorer 106 stores (206) data obtained from the IT assets in the data store 110. In one example the data is stored as it is received or deduced from the IT asset. In another example the network explorer 106 formats or pre-processes the data prior to it being stored in the data store 110.

The asset data processor 108 processes (302) the data stored in the data store 110 and updates (304) the data in the data store as appropriate. For example, the data processor may perform housekeeping tasks to remove IT asset data for assets that no longer exist in the IT infrastructure.

In one example the asset data processor 108 processes (302) the data to ensure it is formatted in a particular format. In another example, the asset data processor 108 processes (302) the data to determine known relationships between different IT assets, and to update (304) or augment the data in the data store 110 to describe the known relationships. In a yet further example, the asset data processor 108 processes the data to infer relationships between different IT assets, and to update (304) or augment the data in the data store to describe the inferred relationships.

In one example the data stored in the data store 110 is stored in a mark-up description language, such as an XML-type language, or other semantic language.

A browser 112 may then be used to display, based on the data stored in the data store 110, a visualization of the composition and/or structure of the hardware and software IT assets 102 in the IT system 100. For example, the browser 112 may enable data of the data store 110 to be browsed, explored, visualized, etc. An IT manager using the browser 112 may therefore be able to gain a thorough, accurate, and up-to-date, view of the IT system 100, and use that knowledge to manage the IT system 100. For IT managers, such ability may prove extremely valuable. For example, an IT manager may be able to quickly determine how many different versions of an operating system are used within the IT system 100, which firmware versions for a particular hardware component are used within the IT system. Such information may, for example, enable an IT manager to plan system maintenance or upgrades to rationalize, simplify, update, etc. the IT system 100.

A further more detailed example of the present invention will now be described with additional reference to FIGS. 4, 5, 6, 7, and 8.

FIG. 4 shows an IT system 400. The IT system 400 includes a number of hardware IT assets 402 connected to a network 406. The system 400 additionally comprises a network explorer 408, an asset data processor 410, itself comprising a data pre-processor 412 and an inference engine 414, a data store 418, and a browser 416.

In one example, illustrated in FIG. 5, at least part of the IT system 400 may be implemented using a microprocessor 502 coupled, via a communication bus 508, to a memory 504 and an input/output module 506. The memory 552 stores network explorer instructions 508, data aggregator instructions 510, and inference engine instructions 512. The instructions 508, 510, and 512 are processor understandable instructions that when executed by the processor 508 provide functionality of the network explorer 408, the data pre-processor 412, and the inference engine 414.

Each of the hardware IT assets 402 includes asset description data 404 that is stored in a memory or other suitable storage medium in the hardware IT asset 402. The asset description data 404 may be stored in any suitable format, for example, in a mark-up description language, such as XML, HTML, or the like. The IT asset description data 404 is obtainable from the IT asset 402 in a predetermined manner, for example such as through use of the HTTP protocol. In this way, the IT asset description data 404 is retrievable by a network explorer, such as the network explorer 408 in response to the network explorer 408 sending a suitable HTTP message to the IT asset 402. In one example, each hardware IT asset stores the asset description data in the RDFa (resource description framework in attributes) format.

At 602, the network explorer 408 discovers hardware IT assets 402 on the network 406 in any appropriate manner. For example, as previously described, the network explorer 408 may operate like a web crawler, using a systematic or methodical approach to exploring network addresses within the network address space of the IT system 400. In another example, the network explorer 106 may be supplied with or obtain a list of known network addresses allocated to hardware IT assets, and may explore the known network addresses. The known network addresses may, for example, be provided by a network element such as dynamic host configuration protocol (DHCP) router or server.

When the network explorer 408 discovers a hardware IT asset at a network address it obtains (604) the IT asset description 404 from the hardware IT asset. In one example, this achieved by the network explorer 408 sending a predetermined message or control signal, such as a HTTP message, to the discovered hardware IT asset. In one example the IT asset descriptions are in a mark-up language, such as XML or HTML. The network explorer 408 then provides (606) the obtained IT asset description data to the asset data processor 410. As previously mentioned, the IT asset description data may include data describing characteristics of the hardware IT asset. In another example, the IT asset description data may additionally include data describing characteristics of software IT assets on the hardware IT asset.

The network explorer 408 continues to explore hardware IT assets in the IT system 400, and reports any IT asset description data back to the asset data processor 410. In one example, the network explorer 408 repeatedly and continuously explores the IT system 400 to discover hardware IT assets. The network explorer 408 may, for example, explore the whole of the IT system address space in a systematic manner, and then re-explore the whole of the IT system address space in a continuous manner. In some examples, the network explorer 408 may pause between re-exploring the IT system 400. In some examples, the network explorer 408 may pause for a predetermined amount of time after having explored each network address, to avoid saturating the network 406 with requests or messages. In other examples, the network explorer 408 may explore the network 406 only when it determines that the network activity is below a predetermined threshold.

The data pre-processor 412 receives (702) IT asset data from the network explorer 408 and processes (704) the IT asset data before storing it (706) in the data store 418. The data store 418 may be an enterprise architecture data store. The processing (704) performed by the data pre-processor 412 may include, for example, formatting the asset description data into a suitable format, aggregating the data, or the like. In one example the asset description data is stored in an XHTML RDFa format.

The data pre-processor 412 then stores (706) the IT asset descriptions in the data store 418. In one example, the data pre-processor 412 performs no processing on the obtained IT asset descriptions other than storing it in the data store 418.

In a further example the IT system 400 may include additional IT assets 401 that do not include asset description data 404. In this example, the network explorer 406 operates to obtain, where possible or where appropriate, IT asset description data through use of any suitable techniques, such as probing, or inspection as described above.

When a sufficient amount of IT asset description data is stored in the data store 418 the inference engine 414 processes the stored IT asset description data to determine (804) relationships between different ones of the IT assets 402 for which IT asset description data is stored in the data store 418.

The determined relationships that may be derivable based on the asset data stored in the data store 418. Such relationships may, include, for example, relationships between hardware IT assets based on characteristics of the hardware IT assets, such as network address, sub-net, processor type, memory capacity, storage capacity, functionality, geographic location, etc. Relationships between hardware IT assets may also be determined based on characteristics of their associated software IT assets. For example, relationships may be determined between hardware IT assets having a type of operating system, operating version number, a type of applications on a hardware IT asset, and so on.

Other relationships may be inferred or be inferable from the data stored in the data store 418.

Where a relationship, whether known or inferred, is determined the inference engine 414 adds supplemental data to the asset description data of the related IT assets. The supplemental data may be semantic or metadata, and may be stored in the same format as the IT asset description data stored in the data store 418. For example, the IT asset supplemental data may provide a link or hyperlink to another IT asset with which the IT asset has a relationship. The supplemental data may additionally describe the relationship between the two assets. The supplemental data may also indicate whether the relationship is a known relationship or whether it is an inferred relationship.

The inference engine 414 repeatedly processes the data stored in the data store 418 so that any new or modified data stored therein is taken into account and the supplemental relationship data is kept up-to-date.

The data stored in the IT asset store, as updated by the inference engine 414, is viewable and browsable by a browser application 416. In one example browser application 416 is an Internet browser application. Using the browser application 416 a user, such as an IT manager, can view the IT assets in the IT system 400, may view and explore connections between different ones of the IT assets, and may view and explore relationships, both known and inferred, between different ones of the IT assets. For example, the data processor 410 may format the data in the data store in such a way that it is viewable as a hierarchical set of assets.

In this way, an IT manager may be able to quickly gain an accurate and up-to-date view of the IT system 400, thereby enabling appropriate IT management decisions to be taken.

It will be appreciated that examples and embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples of the present invention. Accordingly, examples provide a program comprising code for implementing a system or method as claimed in any preceding claim and a machine readable storage storing such a program. Still further, examples of the present invention may be conveyed electronically via any medium such as a communication signal carried over a wired or wireless connection and examples suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A system for cataloging assets in a network, the network comprising a plurality of computing devices, at least some of the computing devices including asset description data, the system comprising:
a network explorer to:
send a request on a network address of the network to obtain asset description data;
receive asset description data from a computing device connected to the network address; and
store the retrieved asset description data in a data store, and
an asset description data processor to process the data in the data store to:
identify known relationships between assets in the network;
infer relationships between assets in the network; and
update stored asset description data with relationship data describing any determined or inferred relationships.

2. The system of claim 1, wherein the network explorer is arranged to systematically explore network addresses in the address space of the computer network.

3. The system of claim 1, wherein the asset description data defines hardware characteristics of a computing device.

4. The system of claim 3, wherein the asset description data further defines characteristics of software components on the computing device.

5. The system of claim 1, wherein the network explorer obtains the asset description data in response to sending a hypertext transfer protocol (HTTP) message to a computing device.

6. The system of claim 1, wherein the network explorer is further arranged to format the obtained asset description data into a predetermined format prior to storing it in the data store.

7. The system of claim 1, wherein the asset description data processor updates the data in the data store by adding, to asset description data relating to one asset, hyperlinks to asset description data relating to an other asset.

8. The system of claim 1, wherein the network explorer is further arranged, where it determines that a computing device on the network does not have asset description data, to determine characteristics of the device through probing or inspection.

9. The system of claim 1, further comprising a browser to view and navigate the data stored in the data store.

10. A tangible, machine-readable medium that stores machine-readable instructions executable by a processor to provide a method of cataloging assets in a network, the assets including asset description data describing hardware and software characteristics of the device, the tangible, machine-readable medium comprising:
machine readable instructions that, when executed by the processor, determine a network address of a computing device in the network;
machine readable instructions that, when executed by the processor, send a request on the determined address to receive asset description data from the computing device;
machine readable instructions that, when executed by the processor, store received asset description in a data store;
machine readable instructions that, when executed by the processor, process the data in the data store to determine relationships between assets; and
machine readable instructions that, when executed by the processor, update stored asset description data for a device with relationship data describing and determined relationship.

11. The tangible, machine-readable medium of claim 10, that further includes machine readable instructions that, when executed by the processor, process data in the data store to infer relationships between assets in the network.

12. The tangible, machine-readable medium of claim 10, that further includes machine readable instructions that, when executed by the processor, determine a network address of a computing device in the network by systematically exploring network addresses in the address space of the network.

13. The tangible, machine-readable medium of claim 10, that further includes machine readable instructions that, when executed by a processor, obtain asset description data in response to sending a hypertext transfer protocol (HTTP) message to a computing device.

14. The tangible, machine-readable medium of claim 10, that further includes machine readable instructions that, when executed by a processor, provide a browser to browse the stored data and enable the stored data to be visualized.

15. A system for cataloging assets in a network, the system comprising:
a plurality of computing devices each including asset description data, describing hardware and software characteristics of the device;
a network explorer to:
determine a network address of a computing device in the network;
send a request on the determined network address to obtain asset description data from the computing device;
obtain asset description data from the computing device; and store the retrieved asset description data in a data store; and
an asset description data processor to process the data in the data store to:
identify known relationships between assets in the network;
infer relationships between assets in the network; and
update stored asset description data in the data store with relationship data describing any identified or inferred relationships with other assets.
